(19) United States
(12) Patent Application Publication
(10) Pub. No.: US 2017/0287352 A1
(43) Pub. Date: Oct. 5, 2017

(54) IMPLEMENTING A BUSINESS METHOD FOR TRAINING USER(S) IN DISC PERSONALITY STYLES

(71) Applicant: Joseph Vadala, Midland Park, NJ (US)

(72) Inventor: Joseph Vadala, Midland Park, NJ (US)

(21) Appl. No.: 15/083,696

(22) Filed: Mar. 29, 2016

(51) Int. Cl. G09B 19/00; G09B 5/02

(52) U.S. Cl. CPC G09B 19/00; G09B 5/02

(57) ABSTRACT

The present invention relates to a business method implementing a mnemonic educational process for training the user(s) in the personality style of an individual. The method utilizes the hand formation/gesture to train the user(s) in the DISC personality style of the individual. Further, the motion of the hand formation/gesture is used to aid the communication of the action and motivation of the DISC personality style. Based on the depicted action of the DISC personality style, one or more attributes can be associated with the determined personality style. Further, the training is delivered to the user, which is determined based on the depiction of the motion of the hand formation/gesture along with the associated attribute, for mnemonically aiding the user in all interpersonal and team settings in which assessing personality styles is essential.

### FIELD OF THE INVENTION

The present invention generally relates to a business method for training user(s) in the DISC personality style of an individual based on the hand formation/gesture and more particularly relates to training user(s) based on the hand formation/gesture, along with the motion of the hand formation/gesture captured for depicting the traits, actions, motivations and fears of each personality style.

### BACKGROUND OF THE INVENTION

Currently, there exists a method for assessing an individual's character, temperament, speed, positive/negative behavior, and so on. The method for determining the personality includes facial expressions, hand gestures, energy level, actions, and attitude. However, the method and system does not include any specific hand formations and gestures, and does not implement personality theory for educating users to assess the personality style.

In another application, the disclosure provides a process and an apparatus for implementing a system of animation and a system of teaching finger spelling. Although the process utilizes hand motions, this patent application does not consider hand formations or movements, and does not implement a method for training in DISC personality theory and personality styles.

In another application, the disclosure concerns about reading, language development, and language expression. It utilizes gestures including hand movement or other body parts as symbols, and one of the symbols appears to involve an extended index finger. Further, the application relates to an educational process in the field of reading and language, and is more extensive than just hand shapes and movements.

Hence, there is a need for a business method that utilizes hand formations/gestures to depict or teach a user about the DISC personality style assessment of an individual by implementing an education training method for the user(s).

### SUMMARY OF THE INVENTION

The present invention relates to a business method implementing an educational training for depicting the personality style of an individual based on a hand formation/gesture and motion of the hand formation/gesture, wherein the method comprises of utilizing the hand formation/gesture to teach the assessment of the DISC (Dominance, Influence, Steadiness, and Compliance) personality style of an individual by demonstrating the motion of the hand formation/gesture to depict the action and motivation of the DISC personality of the individual. Further, the method associates one or more attributes with the DISC personality style after the results of an assessment tool, and delivers a training to a user for closely clarifying the DISC personality style after associating the attributes with a mnemonic tool, the motion of the hand formation/gesture analysis results.

### BRIEF DESCRIPTION OF DRAWINGS

FIGS. 1a, 1b, and 1c illustrate a high-energy task-oriented fist formation.

FIGS. 2a, 2b, and 2c illustrate a high-energy people-oriented thumbs-up formation.

FIGS. 3a, 3b, and 3c illustrate a low-energy people-oriented open hand formation.

FIGS. 4a, 4b, 4c, and 4d illustrate a low-energy task-oriented pointing finger formation.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the hand formations and corresponding motion is utilized to depict the actions and motivations of each personality style. The hand formations can be a combination of hand gestures performed by a task-oriented left hand or a people oriented right hand. Further, the various motions associated with these hand formations communicate the strengths, challenges, fears, emotions, and so on, which is commonly referred to as attributes associated with each personality style. The visual hand formations along with the active participation in the teaching method allow the learner to better comprehend the content.

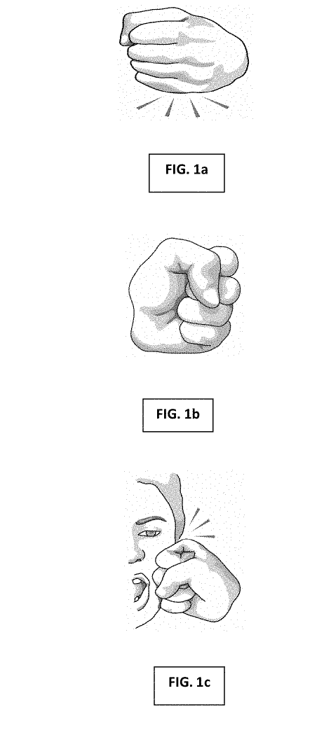

Referring to FIGS. 1a, 1b, and 1c illustrate a high-energy task-oriented fist formation. In an embodiment, the fist formation represents a dominant, driving, high-energy personality that breaks through and gets the task accomplished. Further, the fist formation is represented with a character “D” while assessing the DISC personality style. As depicted in the figure, the fist punches and breaks through to accomplish tasks. The fist pounding down, as on a table, depicts a style that makes firm decisions. The fist to the chin indicates that this personality style fears being taken advantage of; therefore, this personality style is best depicted by being overpowered with a punch.

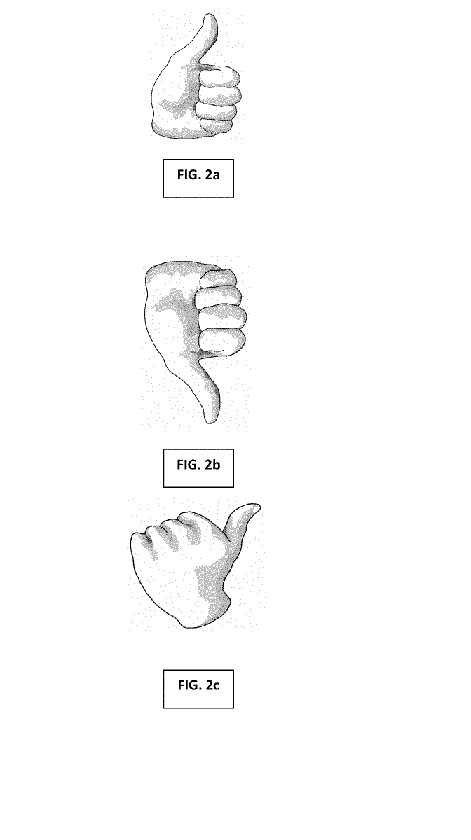

Referring to FIGS. 2a, 2b, and 2c illustrate a high-energy people-oriented thumbs-up formation. In an embodiment, the thumbs up formation represent an influential, inspiring, high-energy personality that communicates with people, networks, and persuades people. Further, the thumbs up formation is represented with a character “I” while assessing the DISC personality style. As depicted in the figure, the thumbs up is positively influencing. The thumbs facing down and motioning outward indicate that this personality style fears rejection; therefore, this personality style is best depicted by a thumb down for lack of approval, and a thumb motioning out for dismissal.

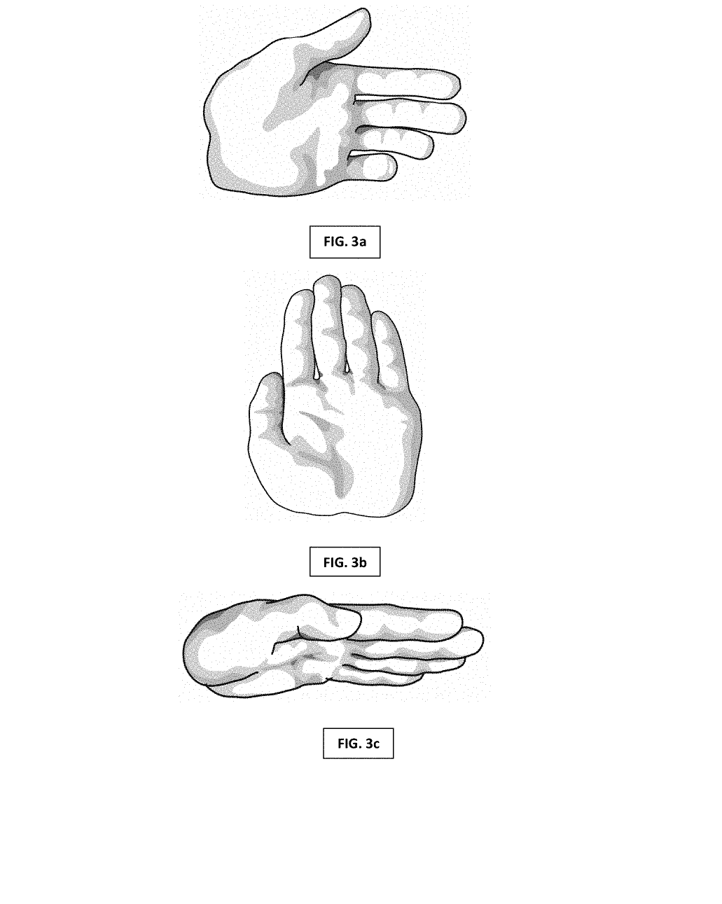

Referring to FIGS. 3a, 3b, and 3c illustrate a low-energy people-oriented open hand formation. In an embodiment, the open hand formation/gesture represents a steady personality enjoying a low-energy, interpersonal connection with people as opposed to lots of people, and are represented as loyal team-players. Further, the open hand formation is represented with a character “S” while assessing the DISC personality style. The open hand is used for shaking hands and patting on the back for interpersonal relationships. Further, the back and forth palm down motion shows that the emotions are not wavering up and down. The open hand that raises up and faces forward indicates that this personality style fears change; therefore, this personality style is best depicted by a hand that raises to communicate “slow down” “stop”.

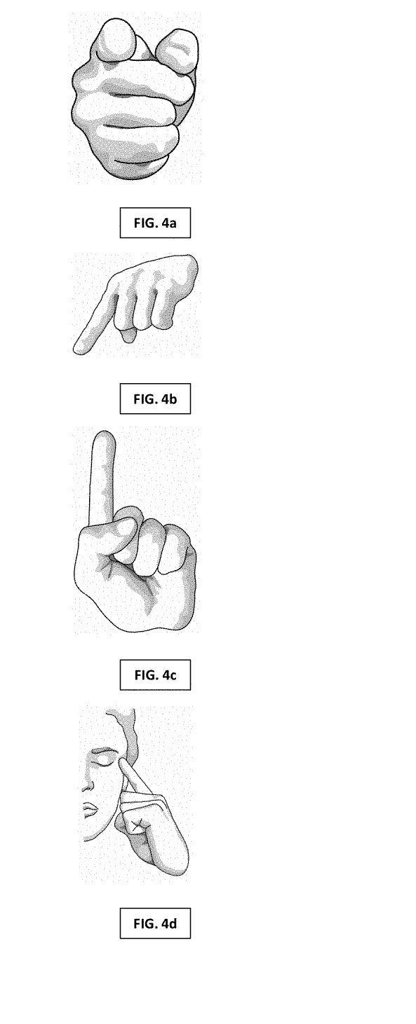

Referring to FIGS. 4a, 4b, 4c, and 4d illustrate a task-oriented pointing finger formation. In an embodiment, the pointing finger formation represents a conscientious, low-energy personality who is good at tasks that involve analyzing and pointing out the details. Further, the pointing finger formation is represented with a character “C” while assessing the DISC personality style. For example, the pointing finger touches the brain to indicate thinking/good ideas and then points all around at the details for getting the task done. The finger pointing directly forward indicates that this personality style fears criticism; therefore, this personality style is best depicted by a finger that points with a critical stance and shakes in accusation.

1. A business method implementing an educational process for training a user in mnemonic tools associated with the personality style of an individual based on a hand formation/gesture and motion of the hand formation/gesture, wherein said method comprises of:
utilizing the hand formation/gesture to teach the DISC (Dominance, Influence, Steadiness, and Compliance) personality style of said individual;
analyzing the motion of the hand formation/gesture to depict the action, motivation, and fear of the DISC personality of said individual;
associating at least one attribute with the DISC personality style after analyzing the motion of the hand formation/gesture; and
delivering training to said user to closely aid in the memory of the assessed DISC personality style after associating said at least one attribute that is determined based on the analysis of the motion of the hand formation/gesture.

2. The method as claimed in claim 1, wherein the hand formation/gesture of a pair of hands along with the motion of the pair of hands can be used to present the DISC personality of said individual.

3. The method as claimed in claim 2, wherein the hand formation/gesture of said pair of hands can be represented with the following personality styles: a fist hand formation/gesture associated with a task-oriented left-hand representing a dominant personality and denoted by a character D; a thumps-up hand formation/gesture associated with a people-oriented right hand, representing an influential personality and denoted by a character I; an open hand formation/gesture associated with the people-oriented right hand, representing a steady personality and denoted by the character S; a pointing finger associated with the task-oriented left-hand representing a conscientious personality and denoted by the character C.

4. The method as claimed in claim 1, wherein said at least one attribute associated with the DISC personality comprises of: a strength factor, a fear factor, a risk-taking factor, a willingness factor, an acceptance related factor, an observance related factor, a reliability factor, or the like.

5. The method as claimed on claim 1, wherein the training delivered to the plurality of users to assess the DISC personality style can be in one of the following forms: through a questionnaire, a video-based training, an E-learning training material, a personality consultant analysis, or the like.
